(19) United States
(12) Patent Application Publication
(10) Pub. No.: US 2009/0133083 A1
(43) Pub. Date: May 21, 2009

(54) PASSIVE CIRCUIT FOR IMPROVED DIFFERENTIAL AMPLIFIER COMMON MODE REJECTION

(75) Inventors: Shaul Klein, Herzelia (IL); Oren Ben-Hamo, Rehovot (IL); Moshe Meir, Rehovot (IL); Ronen Ezra, Kfar Saba (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/943,665

(22) Filed: Nov. 21, 2007

(51) Int. Cl. H04N 7/173

(52) U.S. Cl. 725/111

(57) ABSTRACT

A novel passive circuit for providing improved common mode rejection of a differential amplifier novel. The passive circuit functions to compensate for amplitude mismatches between the two outputs of a differential amplifier. To compensate for the amplitude mismatch between the output traces of the amplifier, a resistor is inserted in series with at either one or both of the differential outputs. The values of the resistors are set such that the mismatch is substantially eliminated. Inductors are connected in parallel with the resistors to create a zero ohm path for power. At high frequencies the inductor impedance is sufficiently high that the series resistor compensates for the imbalance caused by spurious products. The imbalance in the amplifier outputs is corrected with the resulting increase in the rejection of spurious frequency products by exploiting the differential common mode rejection (CMR) effect of the differential amplifier.

### FIELD OF THE INVENTION

The present invention relates to the field of electrical circuits and more particularly relates to a passive circuit for providing improved common mode rejection of a differential amplifier.

### BACKGROUND OF THE INVENTION

Differential amplifiers are well known in the electrical art. A differential amplifier is a type of electronic amplifier that multiplies the difference between two inputs by some constant factor (i.e. the differential gain). A differential amplifier is normally used as the input stage of operational amplifiers (i.e. op amps) and emitter coupled logic gates. The common mode rejection ratio (CMRR) of a differential amplifier measures the tendency of the device to reject input signals common to both input leads. A high CMRR is important in applications where the signal of interest is represented by a small voltage fluctuation superimposed on a voltage offset (which may be rather large) or when relevant information is contained in the voltage difference between two signals. One example of this is audio signal transmission over balanced lines.

In applications, where the power supply for the amplifier is fed through a balun, it is desirable to improve the common mode rejection of the differential amplifier, power fed through a balun. Noise and other interference signals, such as from high frequency noise generated by digital logic circuitry located nearby, can be induced on the power supply inputs in an asymmetric manner. Since the noise and interference is not common across the inputs, it is amplified and present in the differential outputs.

In the case of high speed digital logic circuitry, spurious frequency products are coupled to the amplifier differential output, in an asymmetric manner, i.e. each one of the differential traces sees the spurious products at different amplitudes. There is thus a need for a circuit that is able to increase the rejection of these spurious products. In applications where the differential traces also function as the DC power feed to the amplifier, the circuit should be able to reduce these frequency spurs while not interfering with the DC power supply feed to the differential amplifier. In addition, the circuit should be inexpensive to implement and simple to manufacture without requiring a major change to existing circuit designs.

### SUMMARY OF THE INVENTION

The present invention is a novel passive circuit for providing improved common mode rejection of a differential amplifier. The novel passive circuit functions to compensate for amplitude mismatches between the two outputs of a differential amplifier. The amplitude mismatch compensation circuit of the present invention is especially applicable to cases where the differential traces also serve as the DC power supply feed. One example is use in a cable modem system adapted to implement the DOCSIS specification.

In order to compensate for the amplitude mismatch between the output traces of the amplifier, a resistor is inserted in series with at either one or both of the differential outputs. The values of the resistors are set such that the mismatch is eliminated or substantially eliminated.

In order to not have the resistors interfere with the DC power supply feed to the amplifier, inductors are connected in parallel with the resistors. Thus at DC the amplifier has a zero ohm path (due to the inductor) and the power supply feed is not affected. At high frequencies, however, the inductor impedance is sufficiently high that the series resistor compensates for the imbalance caused by spurious products (i.e. noise or interference sources).

In the example embodiment presented herein, a balun is connected to the output of the differential amplifier. The DC power is fed through the balun to the amplifier via the passive parallel R-L circuits in series therewith. The imbalance in the amplifier outputs is corrected with the resulting increase in the rejection of spurious frequency products by exploiting the differential common mode rejection (CMR) effect of the differential amplifier.

To aid in understanding the principles of the present invention, the description is provided in the context of a DOCSIS capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which can benefit from improved common mode rejection of a differential amplifier.

Several advantages of the amplitude mismatch compensation circuit of the present invention include (1) the common mode rejection of spurious frequency products is significantly improved using a relatively simple passive circuit comprising a few passive components; (2) the cost of the several passive components is extremely low; and (3) implementation of the invention in existing circuit designs does not require extensive and expensive redesign.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a circuit comprising a differential amplifier operative to generate a differential output comprising a first output and a second output, a parallel R-L circuit connected in series with the first output and wherein the R-L circuit is operative to substantially compensate for any amplifier mismatch between the first output and the second output.

There is also provided in accordance with the invention, a circuit comprising a differential amplifier operative to generate a differential output comprising a first output and a second output, a first parallel R-L circuit connected in series with the first output, a second parallel R-L circuit connected in series with the second output and wherein the first R-L circuit and the second R-L circuit are operative to substantially compensate for any amplifier mismatch between the first output and the second output.

There is further provided in accordance with the invention, a circuit comprising first means for compensating for amplifier mismatch between first and second outputs of a differential amplifier and second means for providing a substantially zero impedance path for a DC power supply coupled to the first and second outputs.

There is also provided in accordance with the invention, a circuit comprising a differential amplifier operative to generate a differential output comprising a first output and a second output, conversion means having a differential input and a single ended output, the conversion means operative to convert the differential output of the differential amplifier to a single ended signal and to provide DC power to the differential amplifier via a center tap connected to a DC power supply voltage, a first parallel R-L circuit connected in series with the first output and one end of the differential input of the conversion means, a second parallel R-L circuit connected in series with the second output and a second end of the differential input of the conversion means and wherein the first R-L circuit and the second R-L circuit operative to substantially compensate for amplifier mismatch between the first output and the second output while providing a substantially zero impedance path for the DC power supply voltage.

There is further provided in accordance with the invention, a cable modem comprising a memory, one or more interface ports, a downstream system connected to a CATV radio frequency (RF) signal input and operative to output a plurality of channel data therefrom, an upstream system connected to the CATV radio frequency (RF) signal input, the upstream system comprising a differential amplifier operative to generate a differential output comprising a first output and a second output, a balun having a differential input and a single ended output, the balun operative to convert the differential output of the differential amplifier to a single ended signal and to provide DC power to the differential amplifier via a center tap connected to a DC power supply voltage, a first parallel R-L circuit connected in series with the first output and one end of the differential input of the balun, a second parallel R-L circuit connected in series with the second output and a second end of the differential input of the balun, wherein the first R-L circuit and the second R-L circuit operative to substantially compensate for amplifier mismatch between the first output and the second output while providing a substantially zero impedance path for the DC power supply voltage and a processor coupled to the memory, the one or more interface ports, the downstream system and the upstream system, the processor operative to implement a media access control (MAC) layer operative to generate a plurality of output channels.

### BRIEF DESCRIPTION OF THE DRAWINGS

The invention is herein described, by way of example only, with reference to the accompanying drawings, wherein:

FIG. 1 is a block diagram illustrating an example cable modem system incorporating the DOCSIS upstream system of the present invention;

FIG. 2 is a block diagram illustrating an example cable modem incorporating the amplitude mismatch compensation circuit of the present invention;

FIG. 3 is a simplified block diagram illustrating the upstream system incorporating the amplitude mismatch compensation circuit of the present invention in more detail;

FIG. 4A is a schematic diagram illustrating a first example differential amplifier circuit;

FIG. 4B is a schematic diagram illustrating a second example differential amplifier circuit;

FIG. 4C is a schematic diagram illustrating a third example differential amplifier circuit;

FIG. 5A is a schematic diagram illustrating a first example upstream circuit;

FIG. 5B is a schematic diagram illustrating a second example upstream circuit;

FIG. 5C is a schematic diagram illustrating a third example upstream circuit incorporating the amplitude mismatch compensation circuit of the present invention;

FIG. 6 is a block diagram illustrating a simulation of the amplitude mismatch compensation mechanism of the present invention;

FIG. 7 is a diagram illustrating the signal and spur levels of simulation results of the simulation test of FIG. 6; and

FIG. 8 is a diagram illustrating the further reduction in spur level with the use of a series resistor inserted in one of the branches.

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| ASIC | Application Specific Integrated Circuit |
| ATM | Asynchronous Transfer Mode |
| CATV | Community Antenna Television or Cable TV |
| CM | Cable Modem |
| CMR | Common Mode Rejection |
| CMRR | Common Mode Rejection Ratio |
| CMTS | Cable Modem Termination System |
| CO | Central Office |
| CPU | Central Processing Unit |
| DAC | Digital to Analog Converter |
| DC | Direct Current |
| DCAS | Downloadable Conditional Access Systems |
| DECT | Digital Enhanced Cordless Telecommunications |
| DHCP | Dynamic Host Control Protocol |
| DOCSIS | Data Over Cable Service Interface Specification |
| DS | Downstream |
| DSL | Digital Subscriber Line |
| DSP | Digital Signal Processor |
| DVR | Digital Video Recorder |
| EEROM | Electrically Erasable Read Only Memory |
| FPGA | Field Programmable Gate Array |
| GPIO | General Purpose I/O |
| HDL | Hardware Description Language |
| I/F | Interface |
| I/O | Input/Output |
| IC | Integrated Circuit |
| IP | Internet Protocol |
| IRF | Image Reject Filter |
| LAN | Local Area Network |
| LED | Light Emitting Diode |
| LPF | Low Pass Filter |
| MAC | Media Access Control |
| MPEG | Moving Picture Experts Group |
| PC | Personal Computer |
| PDA | Personal Digital Assistant |
| PGA | Programmable Gain Amplifier |
| POTS | Plain Old Telephone Service |
| PSTN | Public Switched Telephone Network |
| QoS | Quality of Service |
| QPSK | Quadrature Phase Shift Keying |
| RAM | Random Access Memory |
| RF | Radio Frequency |
| ROM | Read Only Memory |
| SLIC | Subscriber Line Interface Card |
| SONET | Synchronous Optical Network |
| TB | Tuning Band |
| US | Upstream |
| USB | Universal Serial Bus |
| VoIP | Voice over IP |
| WAN | Wide Area Network |
| WLAN | Wireless Local Area Network |

### Detailed Description of the Invention

The present invention is a passive circuit for providing improved common mode rejection of a differential amplifier. The novel passive circuit functions to compensate for amplitude mismatches between the two outputs of a differential amplifier. The amplitude mismatch compensation circuit of the present invention is especially applicable to cases where the differential traces also serve as the DC power supply feed. One example is use in a cable modem (CM) system adapted to implement the DOCSIS specification.

To aid in understanding the principles of the present invention, the description is provided in the context of a DOCSIS capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which can benefit from improved common mode rejection of a differential amplifier.

To aid in understanding the invention, the amplitude mismatch compensation mechanism, i.e. programmable gain amplifier (PGA) mechanism, is described in the context of an upstream circuit within the cable modem. It is not intended, however, that the invention be limited to this example PGA circuit, as one skilled in the art can implement the compensation circuit in numerous other differential amplifier circuit applications without departing from the scope of the invention.

Note that throughout this document, the term communications device is defined as any apparatus or mechanism adapted to transmit, or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof.

The term cable modem is defined as a modem that provides access to a data signal sent over the cable television infrastructure. The term voice cable modem is defined as a cable modem that incorporates VoIP capabilities to provide telephone services to subscribers.

### Cable System Incorporating Amplitude Mismatch Compensation Circuit

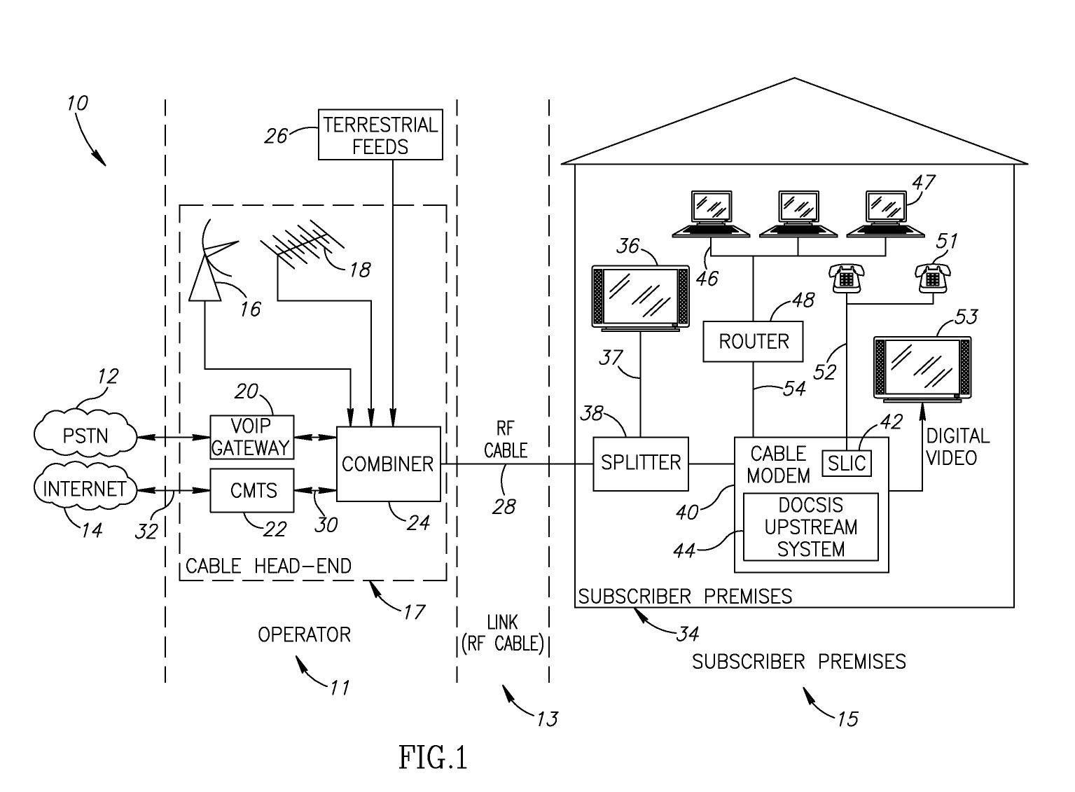

A block diagram illustrating an example cable modem system incorporating the DOCSIS upstream system of the present invention is shown in FIG. 1. The system, generally referenced 10, comprises an operator portion 11 connected to the public switched telephone network (PSTN) 12 and the Internet 14 or other wide area network (WAN), a link portion 13 comprising the RF cable 28 and a subscriber portion 15 comprising the subscriber premises 34.

The operator portion 11 comprises the cable head-end 17 which is adapted to receive a number of content feeds such as satellite 16, local antenna 18 and terrestrial feeds 26, all of which are input to the combiner 24. The cable head-end also comprises the voice over IP (VoIP) gateway 20 and Cable Modem Termination System (CMTS) 22. The combiner merges the TV programming feeds with the RF data from the CMTS.

The Cable Modem Termination System (CMTS) is a computerized device that enables cable modems to send and receive packets over the Internet. The IP packets are typically sent over Layer 2 and may comprise, for example, Ethernet or SONET frames or ATM cell. It inserts IP packets from the Internet into MPEG frames and transmits them to the cable modems in subscriber premises via an RF signal. It does the reverse process coming from the cable modems. A DOCSIS-compliant CMTS enables customer PCs to dynamically obtain IP addresses by acting as a proxy and forwarding DHCP requests to DHCP servers. A CMTS may provide filtering to protect against theft of service and denial of service attacks or against hackers trying to break into the cable operator's system. It may also provide traffic shaping to guarantee a specified quality of service (QoS) to selected customers. A CMTS may also provide bridging or routing capabilities.

The subscriber premises 34 comprises a splitter 38, cable appliances 36 such as televisions, DVRs, etc., cable modem 40, router 48, PCs or other networked computing devices 47 and telephone devices 51. Cable service is provided by the local cable provider wherein the cable signal originates at the cable head end facility 17 and is transmitted over RF cable 28 to the subscriber premises 34 where it enters splitter 38. One output of the splitter goes to the televisions, set top boxes, and other cable appliances via internal cable wiring 37.

The other output of the splitter comprises the data portion of the signal which is input to the cable modem 40. The cable modem is adapted to provide both Ethernet and USB ports. Typically, a router 48 is connected to the Ethernet port via Ethernet cable 54. One or more network capable computing devices 47, e.g., laptops, PDAs, desktops, etc. are connected to the router 48 via internal Ethernet network wiring 46. In addition, the router may comprise or be connected to a wireless access point that provides a wireless network (e.g., 802.11b/g/a) throughout the subscriber premises.

The cable modem also comprises a subscriber line interface card (SLIC) 42 which provides the call signaling and functions of a conventional local loop to the plurality of installed telephone devices 51 via internal 2-wire telephone wiring 52. In particular, it generates call progress tones including dial tone, ring tone, busy signals, etc. that are normally provided by the local loop from the CO. Since the telephone deices 51 are not connected to the CO, the SLIC in the cable modem must provide these signals in order that the telephone devices operate correctly.

The cable modem also comprises an upstream system 44 incorporating the amplitude mismatch compensation circuit of the present invention (not shown). A digital video output signal generated by the cable modem is displayed to the user (i.e. cable subscribers) via television set 53 (i.e. video display device or other cable appliance). Tuner circuits in the cable modem enable the reception of multiple video channels simultaneously.

### Cable Modem Incorporating Amplitude Mismatch Compensation Circuit

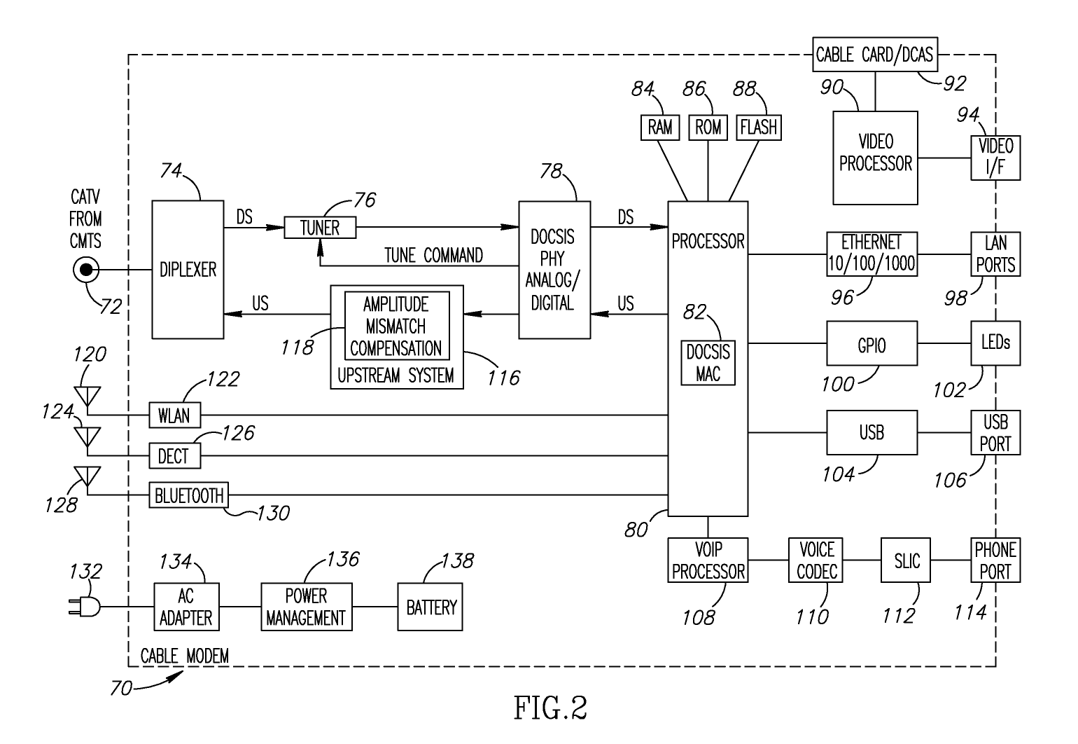

A block diagram illustrating an example cable modem incorporating the amplitude mismatch compensation circuit of the present invention is shown in FIG. 2. The cable modem, generally referenced 70, comprises an upstream system and a downstream system. The downstream system comprises a duplexer 74, tuner 76 and DOCSIS PHY circuit 78. The upstream system comprises the DOCSIS PHY circuit 78, upstream system circuit 116 comprising a DAC, image reject filter, programmable gain amplifier (PGA) (not shown), amplitude mismatch compensation circuit 118 and diplexer 74.

The cable modem also comprises DOCSIS compatible processor 80, DOCSIS MAC 82, VoIP processor 108, voice codec 110, subscriber line interface card (SLIC) 112, phone port 114, wireless local area network (WLAN) 122 and associated antenna 120, DECT 126 and associated antenna 124, Bluetooth 130 and associated antenna 128, Ethernet interface 96, Ethernet LAN port 98, general purpose input/output (I/O) (GPIO) interface 100, LEDs 102, universal serial bus (USB) interface 104, USB port 106, cable card/Downloadable Conditional Access Systems (DCAS) 92, video interface (I/F) 94, video processor 90, AC adapter 134 coupled to mains utility power via plug 132, power management circuit 136, battery 138, RAM, 84, ROM 86 and FLASH memory 88.

Note that in the example embodiment presented herein, the cable modem and DOCSIS enabled processor are adapted to implement the DOCSIS 3.0 standard which provides for multiple channel video reception. It is appreciated, however, that the invention is not limited to use in a DOCSIS compatible cable modem but is applicable to numerous other differential amplifier circuit applications as well.

In operation, the cable modem processor is the core chip set which in the example presented herein comprises a central single integrated circuit (IC) with peripheral functions added. The voice over IP (VoIP) processor 108 implements a mechanism to provide phone service outside the standard telco channel. Chipset DSPs and codecs 110 add the functionality of POTS service for low rate voice data.

The cable modem also comprises a subscriber line interface card (SLIC) 112 which functions to provide the signals and functions of a conventional local loop to a plurality of telephone devices connected via the phone port 114 using internal 2-wire telephone wiring. In particular, it generates call progress tones including dial tone, ring tone, busy signals, etc. that are normally provided by the local loop from the CO. Since the telephone deices are not connected to the CO, the SLIC in the cable modem must provide these signals in order that the telephone devices operate correctly.

In a traditional analog telephone system, each telephone or other communication device (i.e. subscriber unit) is typically interconnected by a pair of wires (commonly referred to as tip and ring or together as subscriber lines, subscriber loop or phone lines) through equipment to a switch at a local telephone company office (central office or CO). At the CO, the tip and ring lines are interconnected to a SLIC which provides required functionality to the subscriber unit. The switches at the central offices are interconnected to provide a network of switches thereby providing communications between a local subscriber and a remote subscriber.

The SLIC is an essential part of the network interface provided to individual analog subscriber units. The functions provided by the SLIC include providing talk battery (between 5 VDC for on-hook and 48 VDC for off-hook), ring voltage (between 70-90 VAC at a frequency of 17-20 Hz), ring trip, off-hook detection, and call progress signals such as ringback, busy, and dial tone.

A SLIC passes call progress tones such as dial tone, busy tone, and ringback tone to the subscriber unit. For the convenience of the subscriber who is initiating the call, these tones normally provided by the central office give an indication of call status. When the calling subscriber lifts the handset or when the subscriber unit otherwise generates an off hook condition, the central office generates a dial tone and supplies it to the calling subscriber unit to indicate the availability of phone service. After the calling subscriber has dialed a phone number of the remote (i.e. answering) subscriber unit, the SLIC passes a ring back sound directed to the calling subscriber to indicate that the network is taking action to signal the remote subscriber, i.e. that the remote subscriber is being rung. Alternatively, if the network determines that the remote subscriber unit is engaged in another call (or is already off-hook), the network generates a busy tone directed to the calling subscriber unit.

The SLIC also acts to identify the status to, or interpret signals generated by, the analog subscriber unit. For example, the SLIC provides −48 volts on the ring line, and 0 volts on the tip line, to the subscriber unit. The analog subscriber unit provides an open circuit when in the on-hook state. In a loop start circuit, the analog subscriber unit goes off-hook by closing, or looping the tip and ring to form a complete electrical circuit. This off-hook condition is detected by the SLIC (whereupon a dial tone is provided to the subscriber). Most residential circuits are configured as loop start circuits.

Connectivity is provided by a standard 10/100/1000 Mbps Ethernet interface 96 and Ethernet LAN ports 98, USB interface 104 and USB ports 106 or with additional chip sets, such as wireless 802.11a/b/g via WLAN interface 122 coupled to antenna 120. In addition, a GPIO interface 100 provides an interface for LEDs 102, etc. The network connectivity functions may also include a router or Ethernet switch core. Note that the DOCSIS MAC 82 and PHY 78 may be integrated into the cable modem processor 80 or may be implemented separately as shown in FIG. 2 wherein the DOCSIS PHY circuit 78 is shown implemented separately from the processor 80.

In the example embodiment presented herein, the tuner 76 is coupled to the CATV signal from the CMTS via port 72 and is operative to convert the RF signal received over the RF cable to an IF frequency in accordance with the tune command signal received from the processor.

The cable modem 70 comprises a processor 80 which may comprise a digital signal processor (DSP), central processing unit (CPU), microcontroller, microprocessor, microcomputer, ASIC, FPGA core or any other suitable processing means. The cable modem also comprises static read only memory (ROM) 86, dynamic main memory 84 and FLASH memory 88 all in communication with the processor via a bus (not shown).

The magnetic or semiconductor based storage device 84 (i.e. RAM) is used for storing application programs and data. The cable modem comprises computer readable storage medium that may include any suitable memory means, including but not limited to, magnetic storage, optical storage, semiconductor volatile or non-volatile memory, biological memory devices, or any other memory storage device.

Any software required to implement the amplitude mismatch compensation circuit of the present invention is adapted to reside on a computer readable medium, such as a magnetic disk within a disk drive unit. Alternatively, the computer readable medium may comprise a floppy disk, removable hard disk, Flash memory, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the amplitude mismatch compensation circuit of the present invention may also reside, in whole or in part, in the static or dynamic main memories or in firmware within the processor of the computer system (i.e. within microcontroller, microprocessor or microcomputer internal memory).

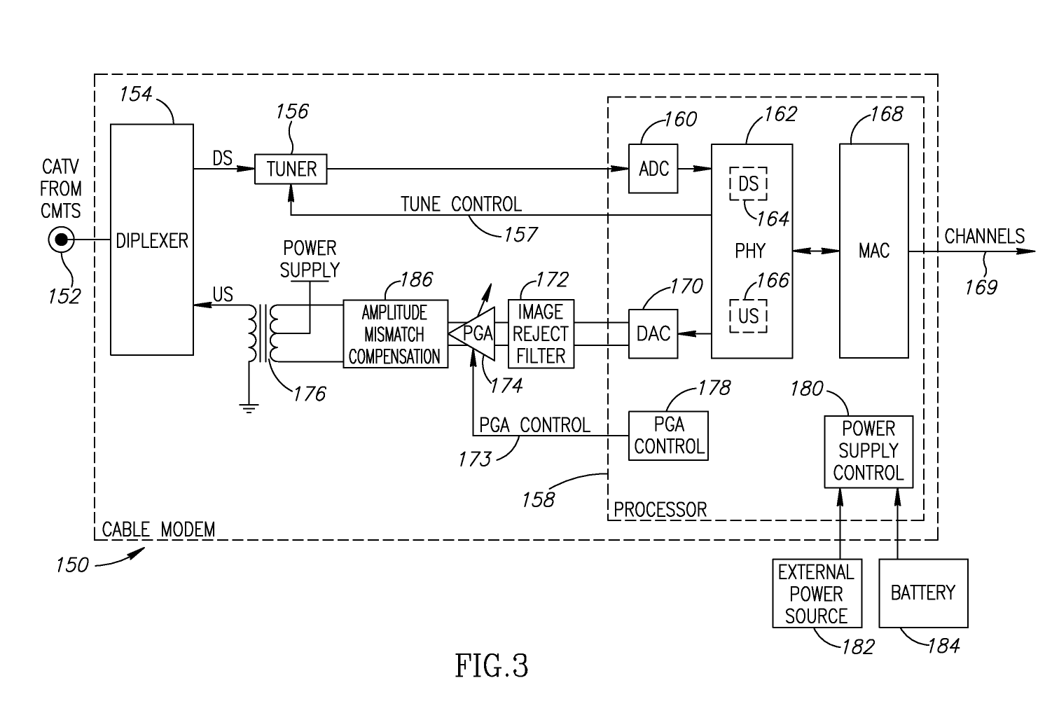

A simplified block diagram illustrating the upstream system of FIG. 2 incorporating the amplitude mismatch compensation circuit of the present invention in more detail is shown in FIG. 3. The example cable modem, generally referenced 150, comprises a diplexer 154 coupled to a CATV input 152, tuner circuit 156, processor 158, image reject filter 172, PGA 174, amplitude mismatch compensation circuit 186 and balun 176. The processor 158 comprises an analog to digital converter (ADC) 160, PHY circuit 162, digital to analog converter (DAC) 170, PGA control circuit 178, power supply control 180 and MAC 168. Power is supplied by an external power source 182, e.g., utility power, etc. or a battery 184.

In operation, in the downstream (DS) (i.e. receive) direction, the receive signal from the diplexer is input to the tuner circuit 156. The tuner output signal is input to the ADC which outputs RX I and Q input signals to the PHY circuit. The PHY circuit provides a tuner control signal 157 that controls the tuning and AGC of the tuner circuit. After MAC processing, one or more channels 169 are output of the cable modem.

In the upstream (US) (i.e. transmit) direction, a digital TX output signal provided by the PHY circuit is converted to analog by the DAC. The analog signal is then filtered via the image reject filter before being amplified by the PGA whose gain is controlled by a PGA control signal 173 generated by the PGA control circuit 178. The differential output of the PGA is input to the amplitude mismatch compensation circuit 186 which functions to compensation for any amplitude mismatches between the two differential output traces from the PGA. The compensated differential signal is converted to a single ended signal via the balun 176 before being input to the diplexer 154.

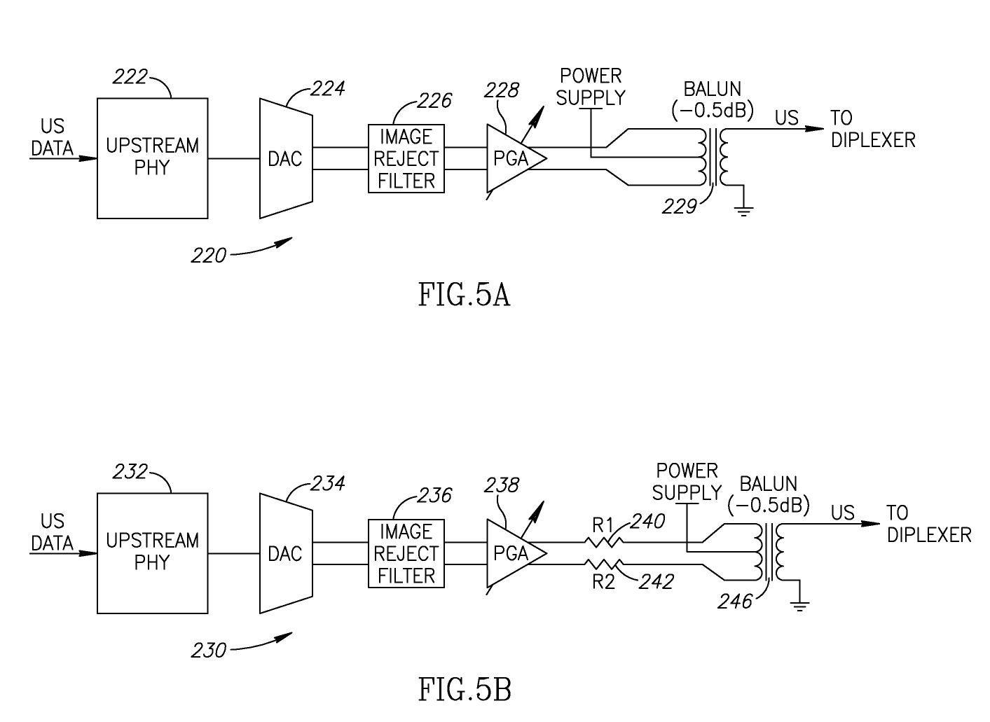

A schematic diagram illustrating a first example DOCSIS upstream (US) circuit is shown in FIG. 5A. The upstream circuit, generally referenced 220, comprises the upstream PHY 222, DAC 224, image reject filter (IRF) 226, Programmable Gain Amplifier (PGA) 228 and balun 229.

In operation, the PHY receives the upstream data to be transmitted from the MAC and generates the digital signals to be transmitted. The DAC then translates the digital signals into analog signals. The image reject filter functions to filter out the image created due to the sampling clock of the DAC. The programmable gain amplifier is a differential amplifier that functions to amplify the analog signal output from the IRF. The balun functions to transform the differential output of the PGA to a single ended signal. The balun also serves to feed a supply voltage from a DC power supply to the output stage of the PGA. The single ended output signal from the balun is input to the diplexer (154 (FIG. 3) which serves to low pass filter (LPF) the signal resulting in better output spectral cleanliness. In addition, the diplexer functions to isolate the upstream transmit signal from the downstream path.

### DOCSIS Upstream Specifications

As an example, the DOCSIS 2.0 specification defines several parameters for the upstream system output. Several tables from the DOCSIS specification are provided below. Table 6-6 defines the required power and modulation for the upstream signal.

TABLE 6-6
Constellation Gains and Power Limits

| | Constellation | | | | | | |
|---|---|---|---|---|---|---|---|
| | Gain G_{const} | | Pₘₐₓ | Pₘₐₓ | | Pₘₐₓ − G_{const} | Pₘₐₓ − G_{const} |
| | Relative to | Pₘᵢₙ | (dBmV) | (dBmV) | Pₘᵢₙ − G_{const} | (dBmV) | (dBmV) |
| Constellation | 64QAM (dB) | (dBmV) | TDMA | S-CDMA | (dBmV) | TDMA | S-CDMA |
| QPSK | −1.18 | 8 | 58 | 53 | 9.18 | 59.18 | 54.18 |
| 8QAM | −0.21 | 8 | 55 | 53 | 8.21 | 55.21 | 53.21 |
| 16QAM | −0.21 | 8 | 55 | 53 | 8.21 | 55.21 | 53.21 |
| 32QAM | 0.00 | 8 | 54 | 53 | 8.00 | 54.00 | 53.00 |
| 84QAM | 0.00 | 8 | 54 | 53 | 8.00 | 54.00 | 53.00 |
| 128QAM | 0.05 | 8 | N/A | 53 | 7.95 | N/A | 52.95 |

Table 6-11 below defines the inband spectral purity requirements.

TABLE 6-11
Spurious Emissions in 5 to 42 MHz Relative
to the Transmitted Burst Power Level

| Possible | Specification | Specification | Initial measurement |
|---|---|---|---|
| modulation rate | in the interval, | in the interval, | interval and distance |
| in this interval | Region 1 | Region 2 | from carrier edge |
| 160 kHz | −54 dBc | −53 dBc | 220 kHz to 380 kHz |
| 320 kHz | −52 dBc | −50 dBc | 240 kHz to 560 kHz |
| 640 kHz | −50 dBc | −47 dBc | 280 kHz to 920 kHz |
| 1280 kHz | −48 dBc | −44 dBc | 360 kHz to 1640 kHz |
| 2560 kHz | −46 dBc | −41 dBc | 520 kHz to 3080 kHz |
| 5120 kHz | −44 dBc | −38 dBc | 840 kHz to 5960 kHz |

As is shown in Table 6-11, the spurious emissions specification defines relatively strict requirements for spectral purity. Spurious products present at the differential output of the PGA create an imbalance which prevents the modem from meeting these requirements.

Table 6-9 below defines the out of band spectral purity as well as the spectral purity between bursts.

TABLE 6-9
Spurious Emissions

| Parameter | Transmitting Burst | Between Bursts |
|---|---|---|
| Inband | −40 dBc | The greater of −72 dBc |
| | | or −59 dBmV |
| Adjacent Band | See Table 6-10 | The greater of −72 dBc |
| | | or −59 dBmV |
| 3 or Fewer | Region 1: −50 dBc for | The greater of −72 dBc |
| Carrier-Related | transmitted modulation | or −59 dBmV |
| Frequency Bands | rate = 320 ksps and | |
| (such as second | above: −47 dBc for | |
| harmonic, | transmitted modulation | |
| if <42 MHz) | rate = 160 ksps | |
| | Region 2: −47 dBc | |
| Bands within 5 to | See Table 6-11 | The greater of −72 dBc |
| 42 MHz | | or −59 dBmV |
| (excluding | | |
| assigned channel, | | |
| adjacent channels, | | |
| and carrier-related | | |
| channels) | | |
| CM Integrated | | |
| Spurious Emissions | | |
| Limits (all in 4 MHz, | | |
| includes discretes)¹ | | |
| 42 to 54 MHz | max(−40 dBc, | −26 dBmV |
| | −26 dBmV) | |
| 54 to 60 MHz | −35 dBmV | −40 dBmV |
| 60 to 88 MHz | −40 dBmV | −40 dBmV |
| 88- to 860 MHz | −45 dBmV | max(−45 dBmV, |
| | | −40 dB ref d/s²) |
| CM Discrete Spurious | | |
| Emissions Limits¹ | | |
| 42 to 54 MHz | −max(−50 dBc, | −36 dBmV |
| | −36 dBmV) | |
| 54 to 86 MHz | −50 dBmV | −50 dBmV |
| 88 to 860 MHz | −50 dBmV | −50 dBmV |

### Upstream Amplifier (PGA) Requirements

Considering DOCSIS requirements, the amplifier in the upstream path should be able to output a 58 dBmV (refer to Table 6-6) signal +3 dB to compensate for diplexer and balun losses for a total of 61 dBmV (for a QPSK signal). A QPSK signal has a peak to average ratio (PAR) of approximately 9 dB, meaning its output signal is 70 dBmVₚₑₐₖ which is equivalent to 76 dBmVₚₜₚ which is equivalent to 6.3 Vₚₜₚ.

In the case of a consumer product (with tight cost constraints) the PGA preferably uses a single power supply of 3.3 V. This requires the PGA to be of differential type to meet the 6.3 Vₚₜₚ requirement, i.e. 3.15 Vₚₜₚ from each one of the branches.

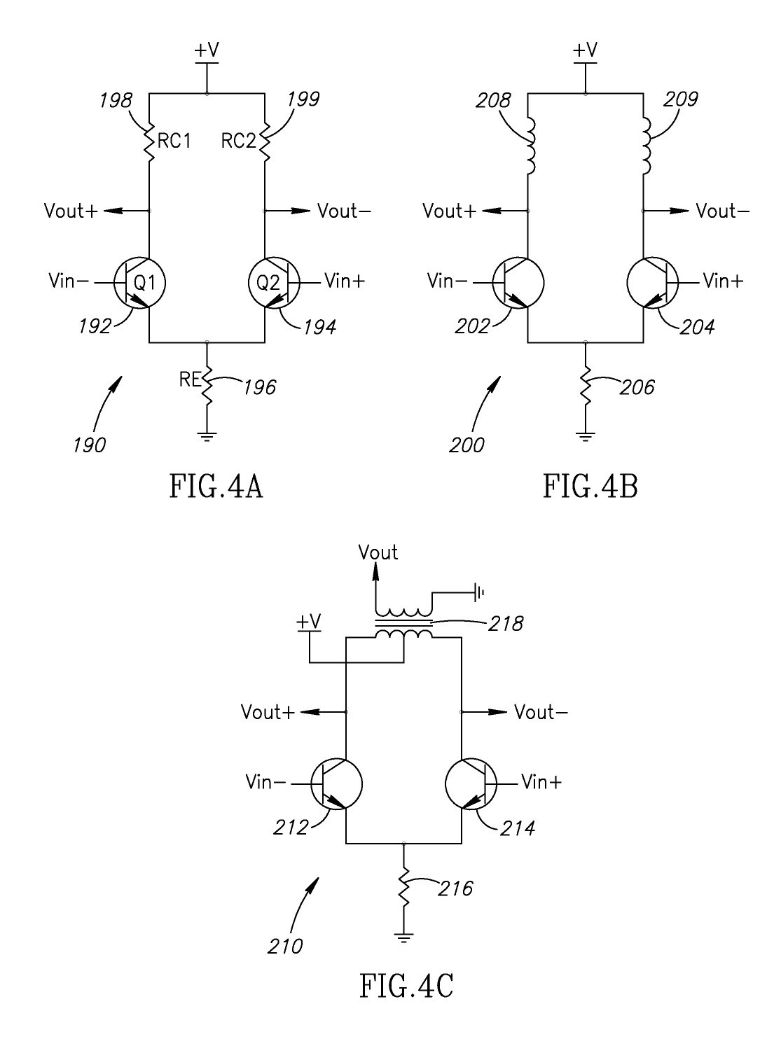

A schematic diagram illustrating a first example differential amplifier circuit is shown in FIG. 4A. The differential amplifier circuit, generally referenced 190, comprises RC1 198 and RC2 199 connected to supply voltage V+, transistors Q1 192 and Q2 194 and emitter resistor RE 196. A differential amplifier is a well known type of electronic amplifier that multiplies the difference between two inputs by some constant factor (i.e. the differential gain). A differential amplifier is normally used as the input stage of operational amplifiers (i.e. op amps) and emitter coupled logic gates. Given two inputs V_{IN+} and V_{IN-}, the differential amplifier generates an output as expressed below

$$\begin{matrix}{V}_{OUT} = {V}_{OUT +} - {V}_{OUT +} \\ = {A}_{D} ( {V}_{IN +} - {V}_{IN -} ) + {A}_{C} ( \frac{{V}_{IN +} + {V}_{IN -}}{2} )\end{matrix} \qquad ( 1 )$$

where

A_{D} represents the differential mode gain;

A_{C} represents the common mode gain;

Note that the output voltage V_{OUT} is limited to values of less then ±V. The common-mode rejection ratio (CMRR) is defined as the ratio between the differential mode gain and common mode gain as follows

$$CMRR = \frac{{A}_{D}}{{A}_{C}} \qquad ( 2 )$$

From Equation 2 above, it can be seen that as A_{C} approaches zero, the CMRR approaches infinity. The higher the resistance of the current source, RE, the lower A_{C} becomes and the better the CMRR. Thus, for a perfectly symmetrical differential amplifier with A_{C}=0, the output voltage is given by the following

V_{OUT}=A_{D}(V_{IN+}−V_{IN-}) (3)

Note that a differential amplifier is a more general form of amplifier than one with a single input. A single-ended amplifier is obtained by grounding one input of a differential amplifier. Differential amplifiers are sometimes found in systems that utilize negative feedback, whereby one input is used for the input signal and the other signal is used for the feedback signal. Common applications include the control of motors or servos and for signal amplification.

The differential amplifier is a circuit that is able to amplify small signals applied between its two inputs, yet reject noise signals common to both inputs. Although the output signal can be tapped from one output only, taking the difference between both outputs provides twice the gain. In addition, the amplifier provides common mode rejection which is useful when the common-mode signal is a noise source or DC bias from a previous stage.

The amplifier functions to amplify differential signals and reject common signals. In operation, consider the bias condition of equal voltages at VB1 and VB2, forcing the bias current IE, which is set by RE, to split equally between the transistors resulting in equal collector currents. With RC1=RC2, equal voltages develop at V_{OUT+} and V_{OUT-}.

When a differential signal is applied to the inputs, the base voltages incrementally increase and decrease. Since Q1 conducts a little more and Q2 a little less, IE splits unevenly resulting in IC1>IC2. This, in turn, forces the voltage at V_{OUT+} to decrease and V_{OUT-} to increase. The result is a voltage change at each output due to a differential input.

When a common-mode input signal is applied to the inputs, both inputs are incrementally increased. Since the conduction level of both Q1 and Q2 have not changed (i.e. both bases and emitters moved by the same amount), the collector currents do not change and IC1=IC2≈IE/2. Thus, the voltages at V_{OUT+} and V_{OUT-} remain the same with the circuit rejecting a signal common to both inputs.

Returning to the DOCSIS requirements presented supra, due to the low inband spurious emission requirement (refer to Table 6-11), high linearity is required, thus necessitating a Class A type amplifier. A Class A amplifier, with high linearity requirement, however, cannot output a signal at an amplitude close to its power supply, such as 3.15 Vₚₜₚ, from a 3.3 V power supply. Thus, in accordance with the invention, an inductor is placed in series with the power supply that effectively doubles the output amplitude of the amplifier. This is shown in the schematic of FIG. 4B, the circuit of which represents one of the final stages in the PGA.

A schematic diagram illustrating a second example differential amplifier circuit is shown in FIG. 4B. The differential amplifier circuit, generally referenced 200, comprises inductors 208, 209 connected to supply voltage V+, transistors 202 and 204 and emitter resistor 206. The output voltage V_{OUT}=V_{OUT+}−V_{OUT+} in this circuit is limited to values of less then ±2V, effectively doubling the dynamic range from the circuit of FIG. 4A.

Further, it is preferable that the output of the differential amplifier be converted to a single ended signal. To achieve this, an external balun is used as shown in the schematic of FIG. 4C, the circuit of which represents one of the final stages in the PGA. A schematic diagram illustrating a third example differential amplifier circuit is shown in FIG. 4C. The differential amplifier circuit, generally referenced 210, comprises balun 218 having a center tap connected to a supply voltage V+, transistors 212 and 214 and emitter resistor 216. To simplify the circuit design, and reduce costs, the balun is used for both the task of (1) providing the power supply feed to the amplifier and (2) performing the differential to single ended conversion. The output voltage V_{OUT} is limited to values of less then ±2V in this case as well.

### Common Mode Rejection

The common mode in a differential amplifier refers to a signal, which may be noise, which is similar in amplitude and phase at its input (V_{IN+} and V_{IN-}). The differential effect which subtracts V_{OUT+}−V_{OUT+} should cancel this signal at the output. If, however, this spurious signal (i.e. noise) enters or exits unbalanced, V_{OUT} will be contaminated having an amplitude mismatch between the outputs. This can be caused by several factors, including different coupling at the input or output, an amplifier malfunction, etc.

In accordance with the invention, a simple passive circuit is provided which functions to compensate for this imbalance. Although the circuit is presented in the context of an upstream system path, it is not intended that the invention not be limited as the circuit can be used in other applications as well.

### Balance Circuitry

The purpose of the balance circuitry is to improve the margins in the presence of frequency spurs which would otherwise cause the cable modem to fail the DOCSIS 2.0 requirements by 5 to 10 dB. In testing performed by the inventors, it was discovered that both the 35 and 70 MHz spurs create an amplitude mismatch on the PGA balanced output. In other words, the frequency spur has a higher amplitude by several dBs on one of the balanced lines with respect to the other.

In accordance with the invention, in order to compensate for the amplitude mismatch between the output lines of the amplifier, a resistor is inserted in series with at either one or both of the differential outputs. The values of the resistors are set such that the mismatch is eliminated or substantially eliminated.

A schematic diagram illustrating a second example upstream circuit is shown in FIG. 5B. The upstream circuit, generally referenced 230, comprises the upstream PHY 232, DAC 234, image reject filter (IRF) 236, Programmable Gain Amplifier (PGA) 238, series resistors R1 240 and R2 242 and balun 246. Series resistors with different values are inserted in series with the output lines. The higher value resistor is placed on the line experiencing a higher spur level, since it will attenuate the spur to the same level as the other line and therefore improve the total rejection, due to the differential effect of the balun. Note that a resistor (or plurality of resistors arranged in a series parallel configuration) can be placed on one line or on both lines of the differential amplifier, depending on the particular implementation.

Since the differential traces also serve as power supply lines, however, the different resistor (or resistors) will cause errors at the PGA output differential stage, because each one of the resistors will have a different voltage drop.

The invention provides a solution to this problem as follows. In order to not have the resistors interfere with the DC power supply feed to the amplifier, inductors are connected in parallel with the resistors. Thus at DC the amplifier has a zero ohm path (due to the inductor) and the power consumption remains correct. At high frequencies, however, the inductor impedance is sufficiently high that the series resistor compensates for the imbalance caused by spurious products (i.e. noise or interference sources).

A schematic diagram illustrating a third example upstream circuit incorporating the amplitude mismatch compensation circuit of the present invention is shown in FIG. 5C. The upstream circuit, generally referenced 250, comprises the upstream PHY 252, DAC 254, image reject filter (IRF) 256, Programmable Gain Amplifier (PGA) 258, amplitude mismatch compensation circuit 260 and balun 269. The amplitude mismatch compensation circuit 260 comprises series resistors R1 264 and R2 266 and inductors L 262, 268.

In operation, DC power is fed through the balun to the amplifier via the passive parallel R-L circuits in series therewith. The imbalance in the amplifier outputs is corrected with the resulting increase in the rejection of spurious frequency products by exploiting the differential common mode rejection (CMR) effect of the differential amplifier and balun.

Thus, placing an inductor in parallel with each of the resistors eliminates any impedance the DC power supply might see by providing a zero ohm path. For RF, however, the differential paths will have different insertion loss (from the resistors) helping to balance the spurious products coupling and thus improving their rejection by the balun.

It is noted that, depending on the implementation, the imbalance between the two differential branches, caused by the different resistors, may cause excessive insertion loss to the main (desired) signal. In most cases, however, this impact will be less significant than the improved spurious rejection, thus resulting in an overall performance gain.

### Simulation of Common Mode Rejection Improvement

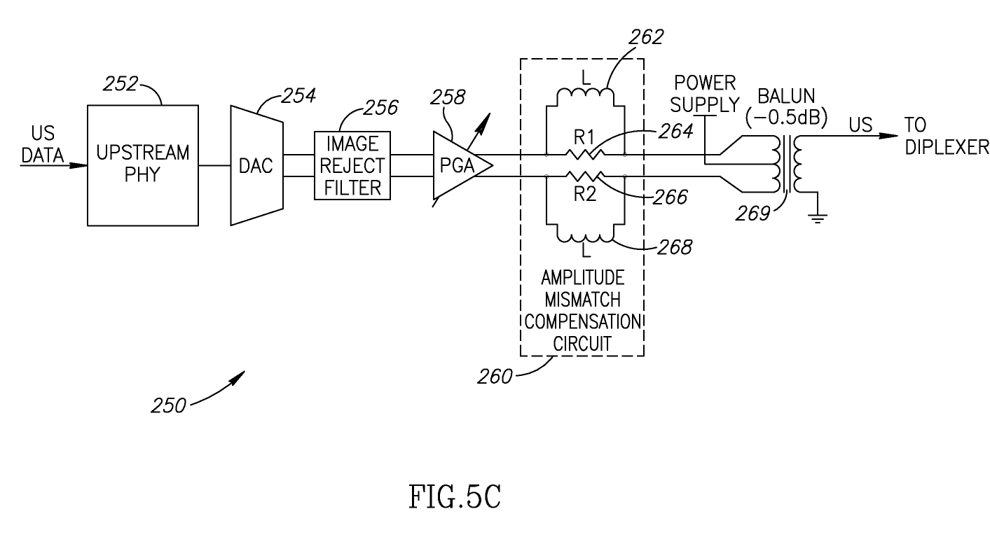

As an aid in illustrating the benefits of the present invention, a simulation of the performance of the amplitude mismatch compensation mechanism and its improvement in common mode rejection is presented below. A block diagram illustrating a simulation of the amplitude mismatch compensation mechanism of the present invention is shown in FIG. 6. The simulation test scenario, generally referenced 270, comprises a first RF input port (PORT1) 272, second RF input port (PORT2) 274, a first branch amplifier 276, a second branch amplifier 278, inductor L1 280, resistor R1 282, balun 284, current probe 286 and load impedance 288.

In order to highlight the impact on both the signal (which is balanced) and the potential spur (common mode noise), an RF signal at a first frequency and phase is inserted into both PORT1 (RF IN1) and PORT2 (RF IN2). A frequency spur at a second frequency and phase is also inserted into both ports PORT1 and PORT2. Note, however, that for the RF input signals there is a 180 degree phase difference between the signals input to PORT1 and PORT2, while the two frequency spur signals have the same phase. The power levels for the spur signal applied to the two branches differ by 6 dB in order to mimic the asymmetric injection (i.e. amplitude mismatch) of the spur signal on the differential traces at the output of the amplifiers. Note also that for simplicity, the amplifiers 276, 278 function to replace the complex transistor stages normally found in the PGA, The signals output of the amplifiers 276, 278 are added through a balun 284. Resistor R1 282, in parallel with inductor L1 280, is varied to show the impact on the spur level and the RF output. The value of L1 in this example simulation is 1000 nH. In addition, the RF signal frequency is 10 MHz at a power level of 0 dBm while the spur frequency is 35 MHz at a power level of −30 dBm.

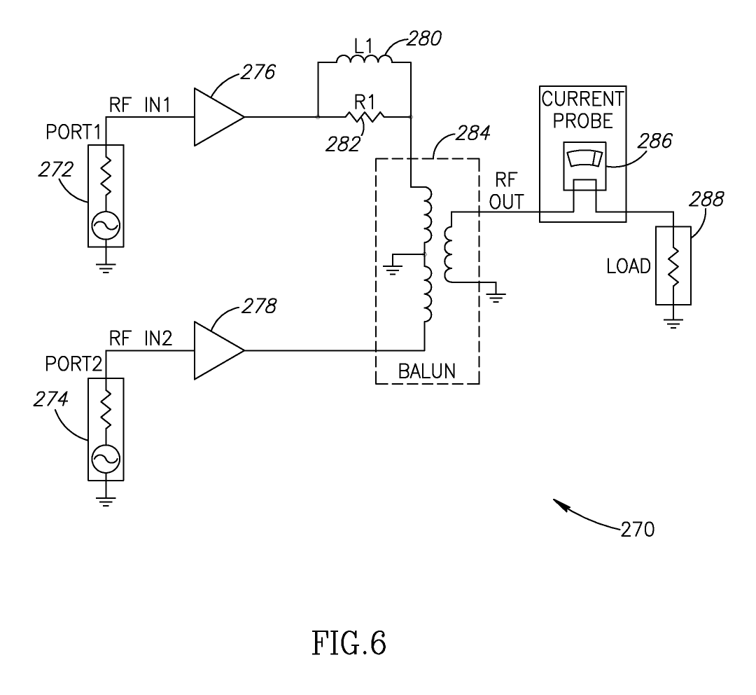

A diagram illustrating the signal and spur levels of simulation results of the simulation circuit of FIG. 6 is shown in FIG. 7. The output spectrum shown in FIG. 7 is for a simulation without the benefit of the present invention, i.e. no series resistor in either of the branches. The baseline performance is shown as output spectrum levels of an RF signal 290 and spur 292. For this simulation, resistor R1 is equal to zero Ohm (i.e. it is not in the circuit). Note that the level of the frequency spur is −42.5 dB below that of the RF signal.

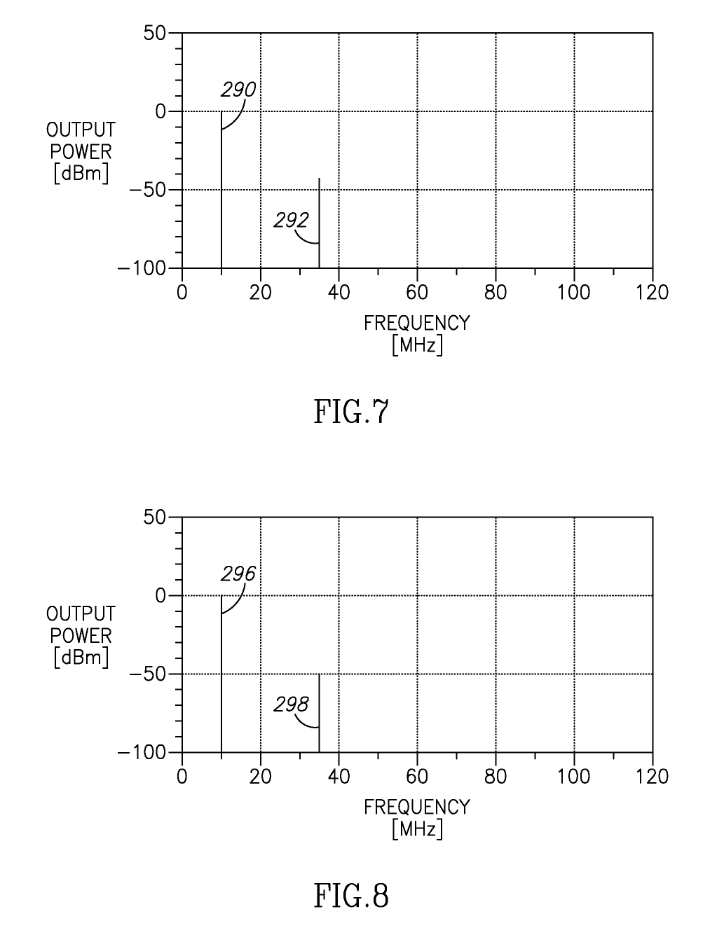

A diagram illustrating the reduction in spur level with the use of a series resister inserted in one of the branches, in accordance with the present invention, is shown in FIG. 8. The performance is shown as output spectrum levels of an RF signal 296 and spur 298. For this simulation, the level of frequency spur rejection is significantly improved by the insertion of a 25 Ohm resistor R1 into the branch that has the higher frequency spur content level. As shown in this simulation, the resultant frequency spur output power level is −50.4 dB below that of the RF signal, an improvement of approximately 8 dB, while the level of the RF signal is only reduced by approximately 0.5 dB.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A circuit, comprising:
a differential amplifier operative to generate a differential output comprising a first output and a second output;
a parallel R-L circuit connected in series with said first output; and
wherein said R-L circuit is operative to substantially compensate for any amplifier mismatch between said first output and said second output.

2. The circuit according to claim 1, wherein said differential amplifier comprises a programmable gain amplifier.

3. The circuit according to claim 1, further comprising a center tapped transformer coupled to said first output and said second output, wherein said center tap is coupled to a power supply and operative to provide power to said differential amplifier via said first output and said second output.

4. The circuit according to claim 1, further comprising a balun coupled to said first output and said second output, wherein the common mode noise rejection of said balun is significantly improved by the operation of said parallel R-L circuit.

5. The circuit according to claim 1, wherein the value of a resistor portion of said parallel R-L circuit is selected so as to compensate for attenuation mismatch between said differential amplifier first and second outputs.

6. The circuit according to claim 1, wherein said parallel R-L circuit comprises a resistor and inductor, wherein said inductor provides a substantially zero impedance path for a power supply input to said differential amplifier.

7. A circuit, comprising:
a differential amplifier operative to generate a differential output comprising a first output and a second output;
a first parallel R-L circuit connected in series with said first output;
a second parallel R-L circuit connected in series with said second output; and
wherein said first R-L circuit and said second R-L circuit are operative to substantially compensate for any amplifier mismatch between said first output and said second output.

8. The circuit according to claim 7, wherein said differential amplifier comprises a programmable gain amplifier.

9. The circuit according to claim 7, further comprising a center tapped transformer coupled to said first output and said second output, wherein said center tap is coupled to a power supply and operative to provide power to said differential amplifier via said first output and said second output.

10. The circuit according to claim 7, further comprising a balun coupled to said first output and said second output, wherein the common mode noise rejection of said balun is significantly improved by the operation of said parallel R-L circuit.

11. The circuit according to claim 7, wherein the values of the resistor portions of said first and second parallel R-L circuits are selected so as to compensate for attenuation mismatch between said differential amplifier first and second outputs.

12. The circuit according to claim 7, wherein said first parallel R-L circuit comprises a first resistor and a first inductor, said second parallel R-L circuit comprises a second resistor and a second inductor, said first inductor and second inductor providing a substantially zero impedance path for a DC power supply input to said differential amplifier.

13. A circuit, comprising:
first means for compensating for amplifier mismatch between first and second outputs of a differential amplifier; and
second means for providing a substantially zero impedance path for a DC power supply coupled to said first and second outputs.

14. The circuit according to claim 13, wherein said first means comprises a resistor connected in series with one of said first output or said second output.

15. The circuit according to claim 13, wherein said first means comprises:
a first resistor connected in series with said first output;
a second resistor connected in series with said second output; and
wherein the values of said first and second resistors are selected so as to substantially compensate for any amplifier mismatch between said first output and said second output.

16. The circuit according to claim 13, wherein said second means comprises an inductor connected in parallel with said resistor.

17. The circuit according to claim 13, wherein said second means comprises:
a first inductor connected in parallel with said first resistor; and
a second inductor connected in parallel with said second resistor.

18. The circuit according to claim 17, wherein the values of said first and second inductors are equal.

19. A circuit, comprising:
a differential amplifier operative to generate a differential output comprising a first output and a second output;
conversion means having a differential input and a single ended output, said conversion means operative to convert the differential output of said differential amplifier to a single ended signal and to provide DC power to said differential amplifier via a center tap connected to a DC power supply voltage;
a first parallel R-L circuit connected in series with said first output and one end of the differential input of said conversion means;
a second parallel R-L circuit connected in series with said second output and a second end of the differential input of said conversion means; and
wherein said first R-L circuit and said second R-L circuit operative to substantially compensate for amplifier mismatch between said first output and said second output while providing a substantially zero impedance path for said DC power supply voltage.

20. The circuit according to claim 19, wherein said circuit is implemented in an upstream path in a Data Over Cable Service Interface Specification (DOCSIS) compatible cable modem.

21. The circuit according to claim 19, wherein said conversion means comprises a signal transformer.

22. The circuit according to claim 19, wherein said conversion means comprises a balun.

23. A cable modem, comprising:
a memory;
one or more interface ports;
a downstream system connected to a CATV radio frequency (RF) signal input and operative to output a plurality of channel data therefrom;
an upstream system connected to said CATV radio frequency (RF) signal input, said upstream system comprising:
a differential amplifier operative to generate a differential output comprising a first output and a second output;
a balun having a differential input and a single ended output, said balun operative to convert the differential output of said differential amplifier to a single ended signal and to provide DC power to said differential amplifier via a center tap connected to a DC power supply voltage;
a first parallel R-L circuit connected in series with said first output and one end of the differential input of said balun;
a second parallel R-L circuit connected in series with said second output and a second end of the differential input of said balun;
wherein said first R-L circuit and said second R-L circuit operative to substantially compensate for amplifier mismatch between said first output and said second output while providing a substantially zero impedance path for said DC power supply voltage; and
a processor coupled to said memory, said one or more interface ports, said downstream system and said upstream system, said processor operative to implement a media access control (MAC) layer operative to generate a plurality of output channels.

24. The cable modem according to claim 23, wherein said plurality of output channels comprises Data Over Cable Service Interface Specification (DOCSIS) channels.

25. The cable modem according to claim 23, wherein the values of the resistor portions of said first and second parallel R-L circuits are selected so as to compensate for attenuation mismatch between said first and second outputs of said differential output.
